(19) United States
(12) Patent Application Publication
(10) Pub. No.: US 2007/0136470 A1
(43) Pub. Date: Jun. 14, 2007

(54) Delivery of localized resource over a network

(75) Inventors: Umachandra Chikkareddy, Redmond, WA (US); Reiner W. Gobel, Snohomish, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/297,843

(22) Filed: Dec. 8, 2005

(51) Int. Cl. G06F 15/173; G06F 17/20; G06F 15/16; G06F 17/00

(52) U.S. Cl. 709/226; 709/203; 704/8; 715/536

(57) ABSTRACT

Localization management. A method may be practiced, for example, in a networked computing environment including a local server. The method includes passing a look-up key from the local server requesting a language key to a server external to the local server. The look-up key specifies a culture for web pages served from the local server. The method further includes receiving the language key from the server external to the local server. The language key includes language information for rendering common content in a language appropriate for the culture specified by the look-up key.

### BACKGROUND

### Background and Relevant Art

Computers and computing systems have affected nearly every aspect of modern living. Computers are generally involved in work, recreation, healthcare, transportation, entertainment, household management, etc. The functionality of computers has also been enhanced by their ability to be interconnected through various network connections.

Networking has allowed for the proliferation of topologies where a server computer can be used to provide web pages to client computers. Web pages allow resources at a server computer or other computers on a network to be easily accessed by providing a visually rich display including links that can be selected using a point and click interface. If the user desires to access a resource on a network, the user can use a mouse pointer to select a link to view other web pages or to download files or other resources.

Often, a group of web pages may be under the control of a single entity or a group of related entities. For example, at a particular web site, a number of pages may be available at the web site. Additionally, entities may often control a number of different but related web sites. When a single entity or group controls a number of web pages or web sites, there is often desire to standardize certain content across all web pages or across similar web pages in a web site or among multiple web sites. For example, with the proliferation of the number of web sites available, there has also been a proliferation of the number of laws regulating information that that is required to be available at a web site. As an example, certain laws require that a privacy policy be available for download when the web site collects information about users logging onto the web site. It may be desirable that the links providing access to the privacy policy and the privacy policy itself be the same across all web pages controlled by a single entity.

Commonly, technology exists at web page servers to allow web pages to be dynamically constructed for delivery to clients connecting to the web page server. For example, the .NET framework available from Microsoft Corporation of Redmond Wash. includes a number of classes that allow for dynamic construction of web pages for delivery to clients. Such frameworks may include DLL files that can be used to define content and layout of web pages constructed for delivery to clients.

The global nature of the Internet means that a web site and web pages may be accessed by a group of very diverse individuals. Each of the individuals in the group may speak different languages. Thus, it is often desirable to provide certain information in a native or standardized language for each individual while nonetheless still conveying the same or similar information commonly irrespective of what language is being used to present the information. One method of providing functionality for different languages is accomplished by having a DLL file at the web page server which includes a resource file with language information encapsulated in the DLL file. Thus, the web page server can appropriately select information from the resources existing at the web page server.

Often, web pages under the control of a single entity have a standardized header and footer. The header is generally information at the top of the web page which may include information related to the entity controlling the web page, partner entities or other information. The footer often includes information such as links to privacy policies, help information, and the like. Web pages may also include standardized information in other parts of the web page as well.

There is often needed to change standardized information that may appear on multiple web pages under the control of a single entity. However, various challenges arise when attempting to change standardized information. For example as described above, language information is often encapsulated as a compiled portion of a DLL file existing at the server. Thus to change the language information, the DLL file is recompiled and distributed to all of the locations hosting web pages for the entity. One challenge that often arises with this example is that a shadow copy of the DLL is being run on a web page server which prevents a new DLL from being used to replace the DLL file. Thus to replace the DLL file, the web server is shut down such that the new DLL can be distributed to the web servers hosting the web pages under the control of the entity.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described in more detail herein includes a method of localization management. The method may be practiced, for example, in a networked computing environment including a local server. The method includes passing a look-up key from the local server requesting a language key to a server external to the local server. The look-up key specifies a culture for web pages served from the local server. The method further includes receiving the language key from the server external to the local server. The language key includes language information for rendering common content in a language appropriate for the culture specified by the look-up key.

Another embodiment includes another method of localization management. The method may be practiced, for example, in a networked computing environment including a local server. The method includes, at an external server external to the local server, receiving a look-up key from the local server requesting a language key. The look-up key specifies a culture for web pages served from the local server. The method further includes passing the language key from the external server to the local server. The language key includes language information for rendering common content in a language appropriate for the culture specified by the look-up key.

Another embodiment includes a computer system for generating web pages for clients. The web pages include common content. The common content can be rendered in a number of different languages. The computer system includes a processor configured to run program modules. The computer system further includes a storage medium configured to store data and program modules. The storage medium includes one or more program module configured to pass a look-up key from the computer system requesting a language key to an server external to the local server. The look-up key specifies a culture for web pages served from the computer system. The program modules may be further configured to receive the language key from the server external to the local server, the language key including language information for rendering common content in a language appropriate for the culture specified by the look-up key

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a topology including a local server, external server and client;

FIG. 2 illustrates a flow chart showing a process whereby localized content can be used for render common content in appropriate languages;

FIG. 3 illustrates a method of localizing content for web pages;

FIG. 4 illustrates another method of localizing content for web pages; and

FIG. 5 illustrates a system where various embodiments may be practiced.

### DETAILED DESCRIPTION

Embodiments herein may comprise a special purpose or general-purpose computer including various computer hardware, as discussed in greater detail below.

One embodiment allows for updating common content. For example, different web pages under the control of a single entity or group may have common content that exists on multiple web pages under the control of the single entity or group. Such content may include for example, header and footer information, common privacy information, or other information. As will be described in more detail below, a local server may implement a resource manager that uses language keys to render the common content in different languages depending on a culture context. The local server may first consult a local cache table to determine language keys exist locally for rendering the common content in a particular language. If a language key is not available at the local server in the cache table, the local server may request a language key from a server external to the local server where the language key includes common content in a particular language. For example, the common content may be a link to a help page. The language key includes text in a particular language that may be associated with or a part of a link such that the help information can be accessed by actuating the link. In one embodiment, the local server requests the language key using a request that includes culture information. The culture information can be used to identify the appropriate language for the language key text. The language key may be requested from a server external to the local server in one embodiment over a link using http (hyper text transfer protocol) or UNC (uniform naming convention).

In one embodiment, language keys for rendering the common content in different languages may be stored with a resource manager for rendering the common content in an updatable cache table in a DLL such that once the language keys have been retrieved from the external server, subsequent requests for the common content can be more quickly serviced than would be available if a request to the external server were made for each of the subsequent requests. The resource manager may include content strings that can use information from the language key to replace the content strings such that the common content can be rendered in the appropriate language.

In one embodiment, the entries in the cache table may have a limited life span such that the entries expire after a period of time so as to allow for the ability to retrieve new information included in the language key should the language key be updated. Alternatively, a file watcher may occasionally ping the external server to determine if language key information has changed. In one embodiment, the file watcher may ping according to a predetermined schedule, which in one embodiment may include predetermined intervals. Once language key information has changed, the file watcher can notify the cache table such that the language key information in the cache table can be invalidated such that a subsequent request for the language information will result in the retrieval of the updated language key from the external server. In particular, one embodiment allows for the invalidation of specific language keys for a specific culture entry. Thus, all entries for a particular item of common content are not necessarily invalidated, but rather, one embodiment contemplates culture specific entries being invalidated.

In one embodiment, the file watcher or another module may cause a pre-fetch, or pre-load to be performed to retrieve the language key prior to a request to a server external to the local server for common content using the language key. The pre-fetched information can be stored locally at the cache table prior to a need to request from an external server. The information in the language key can then be used to create a web page for delivery to a client without the need to fetch the language key from the server external to the local server at the time the web page is created. This can create a more seamless feel for users requesting web pages.

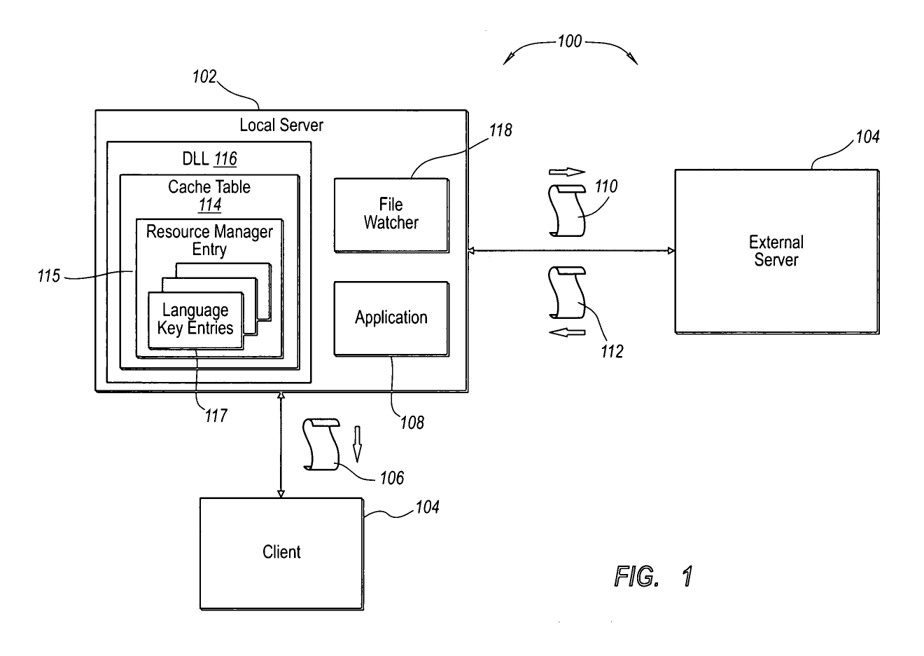

Illustrating now in more detail one embodiment, attention is now directed to FIG. 1 which shows a topology 100 which includes a local server 102 connected to a client 104. A client 104 requests web pages from the local server 102. The local server can deliver web pages 106 to the client 104. In one embodiment, the local server 102 includes an application 108 which dynamically generates web pages 106 delivered to the client 104.

The web pages 106 may include common content, which is content that may be common to a number of different web pages. In one embodiment, the common content, while conveying the same or similar information, may have text in a language appropriate for a given culture context. For example, a web page 106 rendered for English speakers may have the common content displayed in English text. Similarly, for French speakers the common content may be rendered in French. In one embodiment, the common content is embedded in a web page 106 by an application 108.

As illustrated in FIG. 1 the topology 100 includes an external server 104 which is a server external to the local server 102. The external server 104 provides language keys 112 which include common content rendered in a particular language. As such, the local server 102 can send a look-up key 110 to the external server 104. In response, the external server 104 returns a language key 112 to the local server 102. The application 108 can use the language key 112 to render the web page 106 including the common content in a language appropriate for display at the client 104. To obtain the appropriate language key 112, the local server may send culture information in the look-up key 110. In one embodiment, the local server 102 sends an indication of the desired language for the language key 112. For example, the look-up key may include a designation of fr-FR for dialects of French spoken in France. The look-up key 110 may include a designation of en-US for dialects of English spoken in the United States. The look-up key 110 may include a designation of en-UK for dialects of English spoken in the United Kingdom. Alternative and/or additional designations may also be used to though not enumerated here. Additionally, other methods may be used to determine culture such as ip addresses indicating a location and/or other indicators.

In one embodiment, the local server 102 can store language keys 112 or information from the language keys 112 in the cache table 114. In one embodiment, the cache table is a runtime pool using late binding in a DLL 116. By storing the language key 112 in the cache table 114 the information from the language key 112 can be retrieved more quickly for subsequent requests for the common content in the language key 112.

In particular, one embodiment contemplates that the cache table 114 will be consulted prior to requesting a language key 112 from the external server 104. As such, language key information that has been retrieved as the result of a previous look-up key 110 being sent, or as the result of a previous pre-fetch operation, discussed in more detail below, can be readily available for rendering web pages without the need to request the language key 112 at the time that the web page is to be rendered. This can ultimately reduce network congestion and result in a more seamless appearance for users requesting web pages.

The cache table 114 may include a resource manager entry 115. A resource manager is responsible for rendering a particular item of common content. The resource manager may include content strings that can be replaced with information from the language keys 112 to render the common content in an appropriate language. FIG. 1 illustrates language key entries 117 in the resource manager entry 115. The graphical illustration of FIG. 1 is to illustrate the interrelationship of the resource manager entry 115 and the language key entries 117 and be construed to limit that physical organization of the resource manager entry 115 and the language key entries. The relationship shown in FIG. 1 simply illustrates that a single resource manager may use a number of languages keys to render common content using an appropriate language by selecting the appropriate language key for the language.

As described previously, the cache table 114 may be designed to invalidate entries in the cache table 114 after a predetermined period of time. This facilitates the re-fetching of language keys 112 from the external server 104 to replace the invalidated entries in the cache table 114.

In an alternative embodiment, a file watcher 118 may monitor language keys 112 or language key information at the external server 104 to determine when information in the language key 112 at the external server 104 has changed as compared to language key information stored in the cache table 114. In one embodiment, the file watcher 118 may compare time stamps of language key information in the cache table 114 to time stamps of language key information stored at the external server 104. If the language key information at the external server 104 has a later time stamp than the language key information at the cache key 112 which can then be used to dynamically construct a web page 106 and be stored in the cache table 114.

In one alternative embodiment, when language key information in the cache table 114 has been invalidated, a pre-fetch may be used to obtain the new language key information in a language key 112 prior to a request for common content using the language key information. This can ultimately result in less network congestion and a more seamless appearance to users requesting web pages.

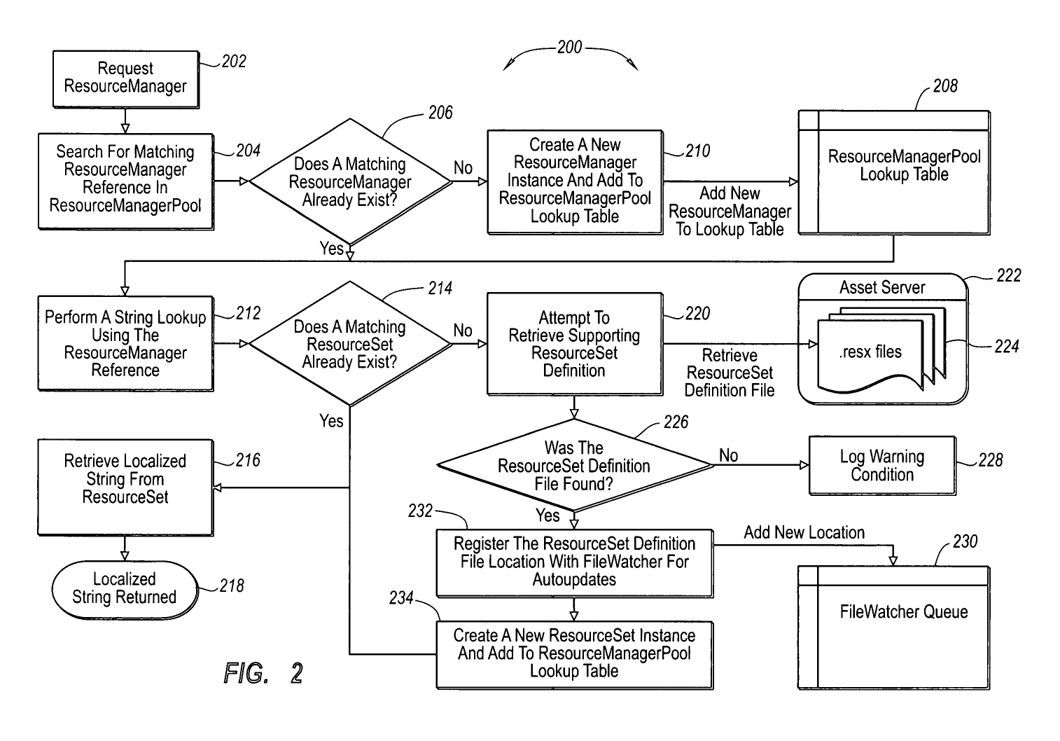

Referring now to FIG. 2, a flowchart 200 illustrating one presently implemented embodiment is illustrated. The flow chart 200 illustrates an action block 202 including requesting a resource manager. A resource manager is a class that is available to define common content information and includes the ability to include strings for a particular language. For example, as described in FIG. 1, it may be desirable to obtain common content in a particular language including information from a language key 112. Thus, an application 108 may request common content for a particular language by requesting a resource manager to provide the common content.

Associated with requesting a resource manager, FIG. 2 illustrates an action block 204 including searching for a matching resource manager reference in a resource manager pool. For example, as illustrated in FIG. 1, the application 108 may request common content for a particular language from the cache table 114 and specifically from the resource manager entry 115.

FIG. 2 further illustrates a decision block 206 that illustrates checking to see if a matching resource manager already exists. If a matching resource manager does not exist, a new resource manager instance is created and added to a resource manager pool lookup table 208 as illustrated by the action block 210. After a new resource manager instance has been created and added to the resource manager pool lookup table 208, or if a resource manager already exists the flowchart 200 illustrates an action block 212 which includes performing a string look-up using the resource manager reference. For example, and referring once again to FIG. 1, performing a string look-up may include attempting to retrieve language key information from the cache table 114 and specifically from one of the language key entries 117. Referring once again to FIG. 2, a decision block 214 illustrates determining if a matching resource set already exists. The resource set may be a string in a language key. Thus, the cache table 114 is examined to determine if the resource set exists. If the resource set exists in the cache table 114, a localized string is retrieved from the resource set as illustrated by action block 216 and returned as illustrated by action block 218. As illustrated in FIG. 1, language key information from the cache table 114 may be returned to the application 108. The language key information can then be used to add common content to the web page 106 for delivery to the client 104.

Referring once again to FIG. 2, if at the decision block 214 it is determined that a matching resource set does not exist, an attempt to retrieve a supporting resource set definition can be affected as illustrated by the action block 220. As shown in FIG. 2, an attempt to retrieve supporting resource set definition files may be accomplished by retrieving resource set definition files at an asset server 222. In the example shown in FIG. 2, the resource set definition files may be .resx files. Referring once again to FIG. 1, an analogous processes illustrated where a local server 102 sends a lookup key 110 to the external server 104 to retrieve a language key 112. In the example shown in FIG. 1, the asset server 222 is one example of the external server 104. The resource set definition file 224 shown in FIG. 2 is one example of a language key 112.

Returning once again to FIG. 2, a decision block 226 is illustrated which illustrates determining whether or not a resource set definition file was found at the asset server 222. In the example shown, if the resource set definition file is not found at the asset server 222, a warning condition is logged as illustrated by the action block 228. If a resource set definition file is found at the asset server 222, the resource set definition file location is registered with a file watcher 230 for automatic updates as illustrated by the action block 232. Illustratively as described previously a file watcher 118 may monitor language keys 112 or language key information on the external server 104. The file watcher 118 can determine that a language key 112 or language key information stored in the cache table 114 has changed at the external server 104 such that the entry in the cache table 114 can be invalidated to allow for retrieval of the changed language key 112.

Referring once again to FIG. 2, an action block 234 illustrates that a new resource set instance can be created and added to the resource manager look up table 208. Additionally, once a resource set definition file has been found at the asset server 222 the resource set definition file can be routed such that it is returned to an application as illustrated by the action block 218.

With respect to FIGS. 1 and 2, one specific illustrative example will now be illustrated. The example herein illustrated is intended only to further clarify various features that may be implemented in various embodiments, and is not intended to limit the scope of all embodiments. This specific example is one that may be implemented by using the .NET framework and various extensions of the .NET framework. Other frameworks may also be used by implementing the principles illustrated without necessarily implementing the specific details of this example.

In one embodiment, the local server 102 creates a base destination (UNC/URL) that is specific to the set of strings to translate. For example, one current implementation uses ContentStrings as the name for the set of strings that are tokenized. For example, client code makes a request through the ResourceManagerPool 208 request to obtain a ResourceManager object for the ContentStrings translation set. Client code then uses this obtained ResourceManager reference to resolve the lookup key by passing the key and culture, for example, French-Canadian, for translation. An exemplary call for accomplishing this may be: “resourceManager.getString(mykey, “fr-CA”)”.

The getString( ) call illustrated above causes the ResourceManager to examine a culture table, such as a table including the language key entries 117 in the cache table 114, looking for a language key match against the culture “fr-CA”. If a key match is not found, the name of the translation set, plus the culture may be used to create a UNC/URL location to obtain the definition from an external server 104 such as the asset server 222. For example, a sample URL might be: “http://translationdefinitionserver/ContentStrings.fr-CA.resx”. If the exact match for the culture “fr-CA” is not found; an attempt may be made to find a match for a broader language set such as just the language French designated by “fr”. For example, a sample URL for obtaining a generic French language key from the asset server 222 may be: “http://translationdefinitionserver/ContentString.fr.resx”.

If the match for broader language fails; an attempt may be made to match just for the “generic” translation set. For example, the following sample URL may be used: “http://translationdefinitionserver/ContentString.resx.”

In each instance illustrated in the specific example above, the formulated URL is looking for a .resx file type in this .NET specific embodiment. Once it has obtained the culture specific or generic copy of the definition it will store it as part of the ResourceManager reference. Because these ResourceManager references are now pooled/cached on the local server 102, there is no reason to access the external server 104 unless the current request is for a culture that has not been previously retrieved.

Invalidation may be specific to a culture. For example, if the definition for “fr-CA” is updated and if a previously retrieved “en-US” definition exists in the ResourceManager reference, “en-US” will not be invalidated when the “fr-CA” reference invalidated. Notably, as discussed previously, the updated “fr-CA” entry can be pre-fetched so that it exists in the cache table 114 when subsequent web page requests are received.

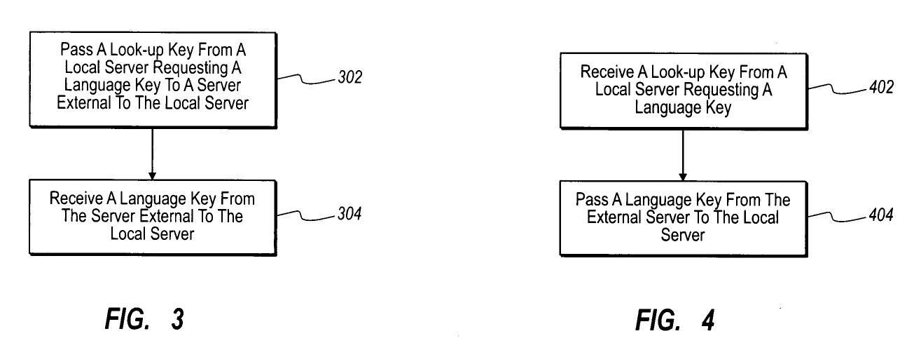

Referring now to FIG. 3, an exemplary method of localization management is illustrated. The method may be practiced for example, in a networked computing environment including a local server. The method includes an act of passing a look-up key from the local server requesting a language key to a server external to the local server (act 302). The look-up key specifies a culture for web pages served from the local server. As described previously and illustrated in FIG. 1, a look-up key 110 can be passed from a local server 102 to an external server 104 requesting the language key 112. In some embodiments, passing a look-up key may include sending at least one of a UNC and/or a http message. For example, the external server 104 may be accessible to the local server 102 through http and/or UNC protocols. In some embodiments, specifying a culture includes specifying a language. In other embodiments, specifying a culture may include specifying a localized ip address, gps coordinates, or any other appropriate information to identify a location, or culture context.

In some embodiments passing a look-up key (act 302) may include including an indication that the look-up key is a distributed request such that a class extended for servicing requests on a distributed network is used to request the language key from the external server. For example, embodiments may exist where certain classes are used to request common content locally at a local server while other extended classes may be used to request common content from servers external to the local server. For example, when requests for language keys are made from a local server 102 to the local server itself, the .NET framework may include classes sufficient to retrieve the language key locally. However, when an external server 104 is accessed, there may be a need to use an extended classes that include functionality for communicating over a network connection to retrieve the language key 112. Various embodiments may use elements of the .NET framework along with extensions to the .NET framework. The following Table illustrates various classes, delegates and enumerations that may be used in some embodiments:

Classes

| Class | Description |
|---|---|
| FileUpdateEventArgs | Provides data for the FileUpdate event. |
| FileWatcher | Static class that watches for changes that |
| | might occur to a file or directory and |
| | fires an event for registered listeners to take action. |
| FileWatcherEntry | Utilized internally by the FileWatcher |
| | class to hold supplemental information |
| | about the file being watched. |
| MissingInvariantResourceException | Custom Missing Invariant Resource Exception |
| ResourceManagerEx | Extends the .Net ResourceManager |
| | Class to provide direct support for .resx |
| | files and providing default values for |
| | GetString( ) and GetObject( ) lookups. |
| ResourceManagerPool | Pools ResourceManagerEx objects to |
| | guarantee that each .resx definition only |
| | has one ResourceManager instance per |
| | application. |
| ResourceUpdateEventArgs | Contains the culture and resource source |
| | location for which the |
| | ResourceUpdateEventHandler was fired. |
| ResXResourceSetEx | Creates an instance of the |
| | ResXResourceSetEx class. |

Delegates

| Delegate | Description |
|---|---|
| FileUpdateEventHandler | Delegate for registering for file updates. |
| ResourceUpdateEventHandler | Event handler delegate for the |

ResourecUpdateEventHandler.

In one embodiment, the method 300 may include an act of checking a cache table to see if a language key is already stored in the cache table locally at the local server. If a language key for the particular culture context is already available, then the act of passing a look-up key (act 302) may not be performed, but rather requests may be serviced by locally stored information. On the other hand, if a language key is not available locally, then passing the look-up key (act 302) will be performed.

Referring once again to FIG. 3, the method 300 further includes an act of receiving the language key from the server external to the local server (act 304). In some embodiments, the language key is returned to the local server. The language key may include language information for rendering common content in a language appropriate for the culture specified by the look-up key.

Receiving the language key (act 304) may include receiving a generic language key when a specific language key is unavailable from the server external to the local server. For example, the server external to the local server may have language keys available that may be used for a generic rendering of the common content when specific content is not available. For example, in some embodiments, if an English language key is available, the English language key will be returned as a generic language key for occasions when more appropriate language keys are not available. For example, if the server external to the local server receives a request that would most appropriately be handled by returning a language key with content in German, but a German language key is not available for the particular common content, and an English language key is available, the English language key will be returned as a generic language key for the German language key request. If no generic key is available, an error may be returned as illustrated by the example of FIG. 2 at the action block 228.

In some embodiments, the method 300 may further include updating a cache table with information from the language key useable to service subsequent requests for the language key. For example, FIG. 1 illustrates a cache table 114 where resource manager entries 115 and language key entries 117 may be used to provide local content to an application 108 for constructing web pages 106.

Some embodiments include registering the information from the language key with a file watcher. The file watcher may be class in a particular framework such as the .NET framework. The file watcher checks to see if language key information has changed at the server external to the local server as compared to the information from the language key. If language key information has changed at the server external to the local server as compared to the information from the language key, the method may further include invalidating the information from the language key in the cache table. This allows the information from the language key in the cache table to be updated when there is a desire to change the common content for a particular language or for all languages.

Invalidating may be performed in some embodiments such that invalidating the information from the language key in the cache table includes invalidating information of a particular language. For example, a resource manager may use different language keys depending on the language the common content will be rendered in for a particular web page. Each of the different language keys may be used for different languages. Thus, if updates are made at the server external to the local server for one of the language keys, only the language key information in the cache table that corresponds to the language key that has been updated at the server external to the local server is invalidated.

In some embodiments, when information has been invalidated, the method 300 may further include pre-fetching a changed language key and updating the cache table with information from the changed language key useable to service subsequent requests for the language key. Thus, the information from an updated language key will be readily available without requiring a fetch from the server external to the local server at the time the information is subsequently requested by an application at the local server, but can rather be retrieved directly from the cache table. In some embodiments, checking to see if language key information has changed may include comparing time stamps. For example language key in the cache table may have a time stamp that indicates when it was created, changed, added to the table, and/or otherwise subject to computing operations. Similarly, language keys at the server external to the local server may have similar time stamps. If the time stamp at the server external to the local server has a time stamp that is later in time to a corresponding time stamp for the language key information in the cache table, the language key information in the cache table may be invalidated.

Referring now to FIG. 4, a method 400 from the perspective of a server external to a local server is illustrated. The method 400 may be practiced, for example, in a networked computing environment including a local server. The method 400 includes an act of receiving a look-up key from the local server requesting a language key (act 402). Receiving a look-up key is performed at an external server external to the local server. The look-up key specifies a culture for web pages served from the local server. As described previously, culture may be specified by specifying a language.

The method 400 may further include an act of passing the language key from the external server to the local server (act 402). The language key includes language information for rendering common content in a language appropriate for the culture specified by the look-up key.

In one embodiment passing a language key may include sending at least one of a UNC and/or a HTTP message.

As described previously, passing the language key may include passing a generic language key when a specific language key is unavailable from the external server.

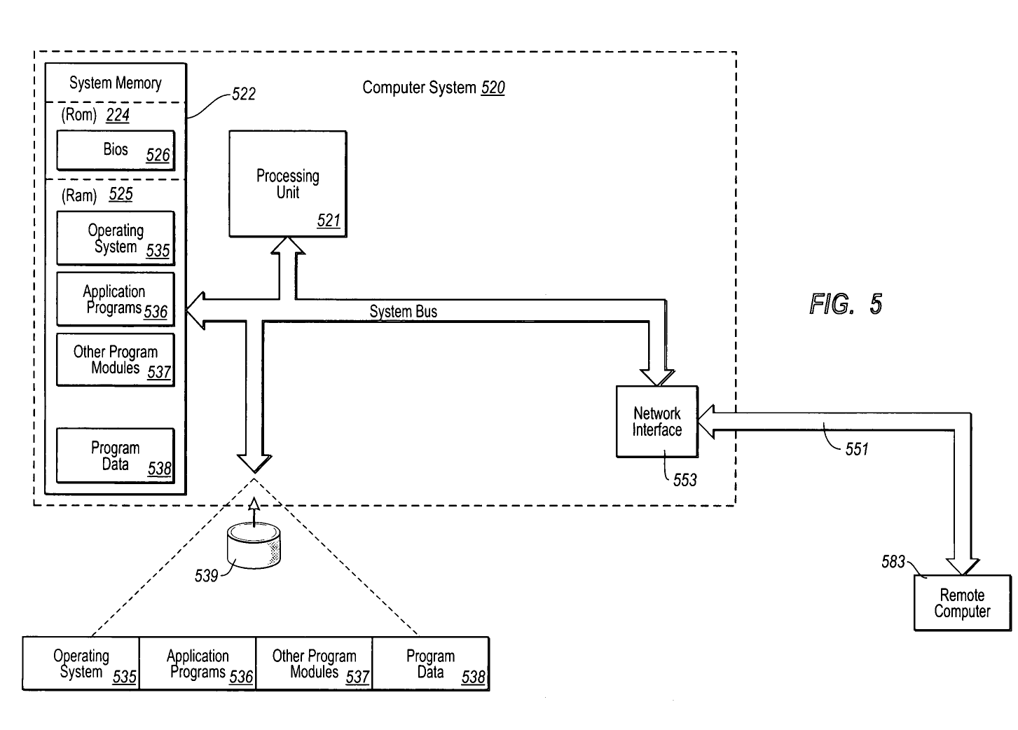

Referring now to FIG. 5, an exemplary computer system 520 is illustrated. The computer system 520 may include functionality for rendering web pages, such as the web page 106 shown in FIG. 1. The web pages may include common content that may be rendered in a number of different languages. The computer system 520 may include a processor 521. The processor 521 is configured to operate on computer executable instructions. For example, the processor may be configured to run instructions stored in the BIOS 526 in ROM 524, as part of an operating system 535 and various program modules including application programs 536 and other program modules 537. These program modules may be stored on non-volatile persistent storage such as a hard disk 539 or other media where they may be loaded into system memory 522 for execution by the processor.

The computer system 520 also includes, as alluded to above, storage media configured to store data and program modules. For example, application programs 536 can be stored on the hard drive 539 where they can be loaded into the RAM 525 of the system memory 522. Similarly, program data 538 may be stored on the hard drive 539 and stored in the RAM 525 of the system memory 522.

A storage medium may include one or more program modules 537 configured to pass a look-up key from the local server requesting a language key to a server external to the local server. As described previously, the look-up key may specify a culture for web pages served from the local server. The program modules 537 may further be configured to receive a language key from the server external to the local server. The language key includes language information for rendering common content in a language appropriate for the culture specified by the look-up key.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a networked computing environment including a local server, a method of localization management, the method comprising:
passing a look-up key from the local server requesting a language key to a server external to the local server, the look-up key specifying a culture for web pages served from the local server; and
receiving the language key from the server external to the local server, the language key including language information for rendering common content in a web page in a language appropriate for the culture specified by the look-up key.

2. The method of claim 1, further comprising updating a cache table with information from the language key useable to service subsequent requests for the language key.

3. The method of claim 2, further comprising registering the information from the language key with a file watcher, wherein the file watcher checks to see if language key information has changed at the server external to the local server as compared to the information from the language key stored at the local server.

4. The method of claim 3, further comprising if language key information has changed. at the server external to the local server has changed as compared to the information from the language key stored at the local server, invalidating the information from the language key in the cache table.

5. The method of claim 4, further comprising pre-fetching a changed language key and updating the cache table with information from the changed language key useable to service subsequent requests for the language key.

6. The method of claim 3, wherein checking to see if language key information has changed comprises comparing time stamps.

7. The method of claim 4, wherein invalidating the information from the language key in the cache table comprises invalidating information of a particular language.

8. The method of claim 1, further comprising checking a cache table including information from one or more language keys to determine if a language key has already been received at the local server.

9. The method of claim 8 wherein the table comprises a runtime pool in a DLL.

10. The method of claim 1, wherein passing a look-up key comprises sending at least one of a UNC and/or a HTTP message.

11. The method of claim 1, wherein specifying a culture comprises specifying a language.

12. The method of claim 1, wherein receiving the language key comprises receiving a generic language key when a specific language key is unavailable from the server external to the local server.

13. The method of claim 1, further comprising including an indication that the look-up key is a distributed request such that a class extended for servicing requests on a distributed network is used to request the language key.

14. In a networked computing environment including a local server, a method of localization management, the method comprising:
at an external server external to the local server, receiving a look-up key from the local server requesting a language key, the look-up key specifying a culture for web pages served from the local server; and
passing the language key from the external server to the local server including language information for rendering common content in a web page in a language appropriate for the culture specified by the look-up key.

15. The method of claim 14, wherein passing a language key comprises sending at least one of a UNC and/or a HTTP message.

16. The method of claim 14, wherein a culture is specified by specifying a language.

17. The method of claim 14, wherein passing the language key comprises passing a generic language key when a specific language key is unavailable from the external server.

18. A computer system for generating web pages for clients, where the web pages include common content, the common content being renderable in a number of different languages, the computer system comprising:
a processor configured to run program modules; and
a storage medium configured to store data and program modules, the storage medium comprising one or more program module configured to:
pass a look-up key from the local server requesting a language key to an server external to the local server, the look-up key specifying a culture for web pages served from the local server; and
receive the language key from the server external to the local server, the language key including language information for rendering common content in a web page in a language appropriate for the culture specified by the look-up key

19. The computer system of claim 18, wherein the one or more program modules are further configured to update a cache table with information from the language key useable to service subsequent requests for the language key.

20. The computer system of claim 18, wherein the one or more program modules are further configured to check a cache table including information from one or more language keys to determine if a language key has already been received at the local server.
